(19) United States
(12) Patent Application Publication
(10) Pub. No.: US 2019/0139076 A1
(43) Pub. Date: May 9, 2019

(54) USING VIRTUAL USER DATASETS TO ANALYZE WEBSITES AND APPLICATIONS

(71) Applicant: OBSERVEPOINT, INC., Provo, UT (US)

(72) Inventors: Kenneth W. Holladay, American Fork, UT (US); Dan Reno, Orem, UT (US)

(21) Appl. No.: 15/966,813

(22) Filed: Apr. 30, 2018

Related U.S. Application Data
(60) Provisional application No. 62/581,475, filed on Nov. 3, 2017.

(51) Int. Cl. G06Q 30/02; G06F 9/455

(52) U.S. Cl. CPC G06Q 30/0242; G06F 9/45558; G06Q 30/0269; G06F 2009/45595; G06F 2009/45583

(57) ABSTRACT

A disclosed system loads a virtual user dataset that comprises a first value and a first dynamic address linking a first access dataset to the first virtual user data field. The first access dataset comprises pre-defined datatypes that each link through the first dynamic address to the first virtual user data field. The system also loads an external digital resource that comprises one or more data entry fields. The system then parses the one or more data entry fields. The system accesses a first value within the first virtual user data field. The system then passes the first value into the first data entry field within the external digital resource. Further, the system initiates an audit of the external digital resource. The system then generates a report based on the audit.

### CROSS-REFERENCE TO RELATED APPLICATIONS

This application claims priority to and the benefit of U.S. Provisional Application Ser. No. 62/581,475 entitled “USING PROFILES TO ANALYZE WEBSITES AND APPLICATIONS”, filed on Nov. 3, 2017, the entire contents of which is incorporated by reference herein in its entirety.

### BACKGROUND

Targeted advertising has long been an ideal method of marketing. In contrast to general marketing that is broadly communicated to the public, targeted advertising attempts to identify particular people with particular interests and then send those particular people advertisements that align with those interests. One will appreciate that such targeted advertising is more efficient and more welcome by the receiver than broadly communicated general marketing.

While targeted advertising has long been a desired outcome for marketing companies, historically it was only achievable in broad sweeping generalizations. For example, automobile manufacturers often attempt to advertise new truck models during football games. The automobile manufacturers hope that the demographic of people who watch football games aligns with the demographic of people who would likely buy a new truck. One will also appreciate, however, that in many cases conventional methods of advertising are either wasted because the receiving audience is outside the desired demographic or wasted because the advertising fails to reach other individuals who are within the desired demographic.

In recent years, the arrival of the internet and its associated media platforms have significantly impacted the ability of marketing companies to target their advertisements. Using conventional tracking tools, marketing companies are now able to track an individual's browsing habits and identify particular advertisements that may be of interest to that user. Further, marketing companies are able to personalize the advertisements on a per user basis.

While this infusion of technology into marketing has significantly benefited the marketing field, it has also generated new and novel technological problems that are particular to the internet. For example, internet marketing is now heavily automated and dynamic making it is difficult to properly audit these marketing systems to ensure that they are functioning according to specifications. This is further complicated by technological distinctions within marketing. For example, a marketing company may automatically detect the type of computing device that a person is using and then send an advertisement that is specially crafted for display on that particular type of computing device. As such, it is not only beneficial to determine that the correct advertisement is being sent, it is also beneficial to determine that the marketing system correctly identified the user's computing device and correctly provided an advertisement that is designed for the identified device.

One will appreciate that a technological problem in any of these steps can have a dramatic impact on the performance of internet-unique advertising. As such, there are several ways in which the art can be improved.

### BRIEF SUMMARY

Disclosed embodiments include methods, systems, and computer-readable medium that are configured for dynamically loading digital audit data. A disclosed system loads, into digital memory, a virtual user dataset that includes one or more characteristics specific to a type of user. The virtual user dataset comprises a first virtual user data field comprising a first value and a first dynamic address linking a first access dataset to the first virtual user data field. The first access dataset comprises a first plurality of pre-defined datatypes that each link through the first dynamic address to the first virtual user data field. The system also loads an external digital resource that comprises one or more data entry fields. The system then parses the one or more data entry fields. Parsing the one or more data entry fields comprises identifying, within the external digital resource, field descriptions associated with each data entry field selected from the one or more data entry fields.

The system also identifies at least one data field description within the first access dataset. The at least one data field description is associated with a first data entry field. The system accesses, through the first dynamic address, the first value within the first virtual user data field. Additionally, the system passes the first value into the first data entry field within the external digital resource. Further, the system initiates an audit of the external digital resource. The audit comprises causing the external digital resource to execute a function, and verifying an output of the external digital resource matches a particular output that is linked to the first value. The system then generates a report based on the audit.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including validating a website or application.

FIG. 2 illustrates an embodiment of a system for validating a website or application.

FIG. 3 illustrates an embodiment of a virtual user dataset.

FIG. 4 illustrates another embodiment of a virtual user dataset.

FIG. 5 illustrates another embodiment of a system for validating a website or application.

FIG. 6 illustrates a flowchart that depicts an embodiment of a method of validating a website or application.

### DETAILED DESCRIPTION

Embodiments described herein are directed to validating a website or application. In at least one embodiment, a computer system accesses a virtual user dataset that includes characteristics specific to a computing environment or type of user. For example, a virtual user dataset may comprise information describing digital characteristics of an individual with a particular name, age, gender, location, and/or interests. One will appreciate, however, that a virtual user dataset may comprise fewer or more characteristics. The computer system then initiates an audit or simulation for a website or application using the characteristics specific to the computing environment or user type. The audit or simulation is run in custom-generated environment that appears to include the characteristics specific to the computing environment or user type. The computer system also generates a report based on the audit or simulation that indicates how the audit or simulation performed.

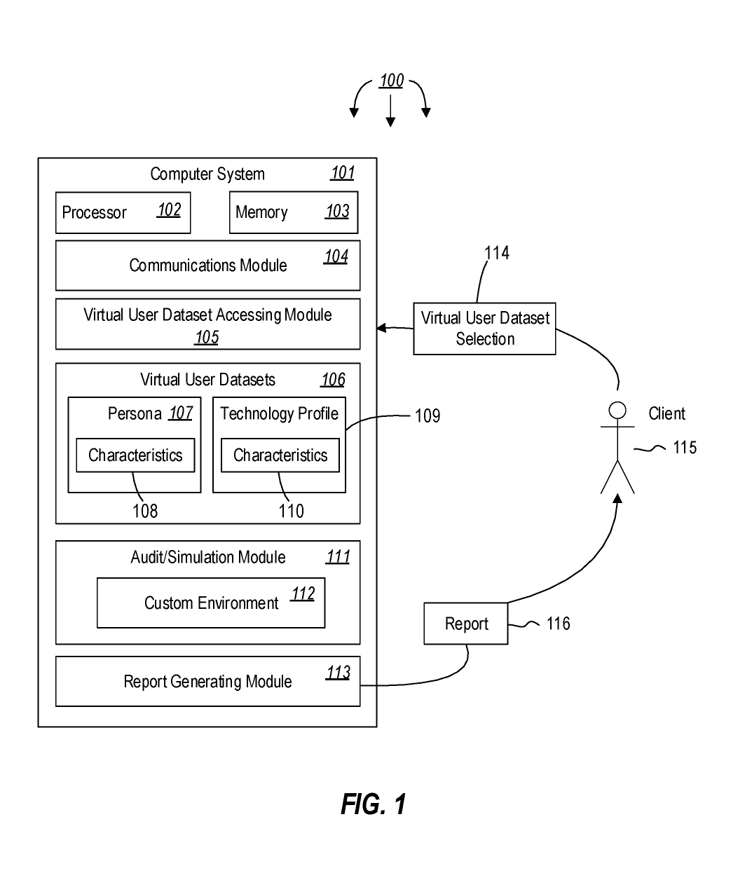

Referring to the figures, FIG. 1 illustrates a computer architecture 100 in which at least one embodiment described herein may be employed. The computer architecture 100 includes a computer system 101. The computer system 101 includes at least one processor 102 and at least some system memory 103. The computer system 101 may be any type of local or distributed computer system, including a cloud computer system. The computer system 101 includes modules for performing a variety of different functions. For instance, communications module 104 may be configured to communicate with other computer systems. The communications module 104 may include any wired or wireless communication means that can receive and/or transmit data to or from other computer systems. The communications module 104 may be configured to interact with databases, mobile computing devices (such as mobile phones or tablets), embedded or other types of computer systems.

The computer system 101 also includes a virtual user dataset accessing module 105. The virtual user dataset accessing module 105 may access one or more virtual user datasets 106 that are used when running audits or simulations. As used herein, the term “audit” refers to a process for checking a website, application or other software-based item for certain expected features or characteristics. The audit ranks the website, application or other software-based item based on whether it has these characteristics and to what degree. Many different types of audits may be performed to check certain functionality or features in a given application or website. The term “simulation,” as used herein, refers to a process for running, rendering, emulating, spoofing or otherwise executing a website, application or other software-based item in a specified environment, such as within a hypervisor that is executing a particular computer environment. The simulation may be part of an audit, but may be performed without performing an audit.

As such, in at least one embodiment, the audit/simulation module 112 performs audits or simulations in a specified custom environment 112. The environment 112 may be based on the virtual user datasets 106 accessed by the virtual user dataset accessing module 105. The virtual user datasets may be provided by a client 115 via virtual user dataset selection 114, or may be provided by another entity. In some cases, the virtual user datasets may be stored locally on computer system 101, while in other cases, the virtual user datasets are stored in an external location (e.g. on cloud data storage). The client 115 may, for example, have a website, application or other software item they wish to audit or at least simulate to see whether the application or website performs as intended. The audit/simulation module 111 may perform this audit or simulation using one or more specified virtual user datasets.

For example, if the client had a website or application that was to appear differently for different types of users (i.e. it was targeted to a specific demographic), a persona 107 from a virtual users dataset 106 may be applied in the audit or simulation such that, when the audit or simulation is performed, it is performed as if it were for that type of user. Similarly, if the client had an application or website that was to load different content, or different formats of content for different devices (e.g. mobile phones, tablets, desktop computers, smart watches, etc.), the audit or simulation may be performed using a technology profile 109.

The technology profile 109 may have different technical features or characteristics that are to be applied in the simulation such as, for example, operating system type, operating system version, browser type and version, hardware capabilities, or other characteristics. Similarly, the persona 107 may have its own corresponding characteristics 108 that are to be applied when performing an audit or simulation. The persona and technology profiles may be applied individually or together, as will be explained further below. Once the audit or simulation has been performed, the report generating module 113 generates a report 116 that is sent back to the client 115 and/or to other recipients.

Thus, in this manner, a client or other user may be able to specify that an audit, simulation or other type of test is to be performed against an application, website, email or text message, or any other type of software implementation to test or verify the functionality, appearance or other characteristics of that software-based item. The audit or simulation may be performed for specific personas or technology profiles, simply by indicating that those virtual user datasets are to be used in the audit or simulation. Once completed, a report is provided to the client, specifying how the application or website performed in each virtual user dataset or virtual user dataset grouping. These concepts will be explained further below with regard to a method embodiment.

In at least one embodiment, a method is described for validating a website, application or other software-based item. Throughout this description, “validating” may refer to auditing, simulating, or performing other operations on a website, application, or other software item. Moreover, although websites or applications may be mentioned individually, it will be understood that the principles described herein apply equally to substantially any software application or other item that is to be validated. In the method mentioned above, a computer system accesses a virtual user dataset that includes characteristics specific to a computing environment or type of user. The characteristics may be user persona characteristics 108, technology profile characteristics, or other types of features or elements that are to be implemented when performing a validation.

The persona 107 may describe a specific individual, a group of individuals, or a type of individual. For example, client 115 may have a specific individual or group of individuals in mind when they produce a version of the website. The client 115 may want that particular version of the website to be provided to the user when they request to view it (e.g. in a browser). The client 115 may provide or select a persona 107 for that user or group of users. The persona 107 may identify those individuals by phone number, email address, login name or other identifying information. The auditing/simulation module 111 may then apply those characteristics when performing an audit or simulation.

In at least one embodiment, the persona 107 is stored in or converted to a data form that is directly useable by a simulated computing environment. For example, the target computing environment may be a webpage. In such a scenario, the persona 107 may be presented as a cookie or some other form of local storage that allows a webserver to read the persona 107 using conventional means. The webserver then provides information that is reactive to the data within the persona 107.

The client 115 may specify a type of individual that is to receive a specified website. For instance, the client 115 may specify a certain demographic (e.g. 20-30 year old Hispanic males) that is to receive version A of the website, while another demographic (e.g. 40-50 year old educated females) is to receive version B of the website. Of course many different demographics can be used, and the above examples were chosen arbitrarily. The characteristics 108 of those types of users may be provided to the audit/simulation module 111, which can then use them in the validation.

Still further, the client 115 may specify, in virtual user dataset selection 114, that a given technology profile 109 is to be used in the validation. The technology profile may indicate a hardware device, operating system, application set, application versions, hardware components, or other characteristics 110 that are to be used in the validation. The technology profile 109 may be used in conjunction with the persona virtual user dataset 107, such that characteristics of both a user type (e.g. teenage girls) and a technology type (e.g. the latest mobile phone from a currently popular brand) are both used in the validation. In some cases, multiple persona virtual user datasets may be used with a single technology profile, while in other cases, multiple technology profiles may be used with a single persona virtual user dataset. Thus, a client may have full control over which environments and targeted user types are used in the validation.

Returning to the method, the computer system can then initiate an audit or simulation for a website or application using the characteristics specific to the computing environment or user type. The audit or simulation may be run in a custom-generated environment that appears to include the characteristics specific to the computing environment or user type. For example, the persona characteristics 108 and the technology profile characteristics 110 may be included in the custom-generated environment 112 in a variety of different ways. For instance, devices, operating systems, browser applications, email clients, and other software may be executed within hypervisors in the environment 112. The emulation acts result in an environment that is substantially similar to or the same as actually running the validation on those devices/operating systems/applications. Similarly, if a persona characteristic specifies that the user is from a given country or part of a country, the user's location may be spoofed by using a proxy server or changing an IP address or wireless identifier. Other methods may also be used to run the validation in the environment desired by the client 115.

Once the validation is finished, the report generating module 113 generates a report 116 based on the audit or simulation that indicates how the audit or simulation performed. The same validation may be run against multiple data sets, simply by selecting which virtual user datasets are to be used. A separate report may be generated for each virtual user dataset configuration. Thus, for example, a report may be generated for a validation that was run against a single persona, another report may be generated for a validation that was run against the same persona in conjunction with a specified technology profile, and another report may be generated for a validation that was run against a single technology profile. Of course, reports may be generated for any number of validations run against any combination of virtual user datasets 106.

In some cases, a persona or a technology profile may include different categorical levels of information. Thus, for example, a persona may include location information, company information and age range, while a technology profile may include an operating system, email client and browser version. Each characteristic may have sub-characteristics that are also to be used during the validation.

Location may be one of the persona characteristics 108. In some embodiments, a user may elect to share their location with other applications or users. In another case, a user's general location may be determined based on IP address, base station connections, Bluetooth connections or other means of identifying and determining the location of a device. Then, when the custom environment 112 is generated for validation purposes, the custom environment uses proxies or other means of spoofing that user's location. In some cases, the custom-generated environment 112 is based on browser history information accessed through browser cookies associated with the user. Again, the environment 112 may use proxy servers, change cookie attributes to appear from a given location, modify browser history, or perform other actions that will run the validation as if from that location.

The client 115 may provide a specific persona or technology profile to use in the validation via a user interface prompt that allows the client to add a persona to an audit. Each persona virtual user dataset may have its own default technology profile that is automatically selected for execution when the corresponding persona virtual user dataset is selected. The client 115 may specify which technology profiles are to be default virtual user datasets for different persona virtual user datasets.

The client 115 may also rank which characteristics of the computing environment or type of user are most useful in creating a custom-generated environment that is closest to a defined use case. For example, if a persona or a technology profile has multiple different characteristics, some of those characteristics may be more important to the client than others. As such, the client may be able to rank which characteristics (e.g. location, cookie attributes, browser history, device type, operating system type, etc.) are most important, and on down. The report may then show how the validation is performed in a manner that is weighted according to the client's ranking. Thus, if the validation failed in some areas of little concern, and passed the validation in areas of greater concern, the client may still be pleased with the overall result. Accordingly, it can be seen that the client has a wide breadth of control over which characteristics are used in each audit or simulation, as well as control over how the results are reported.

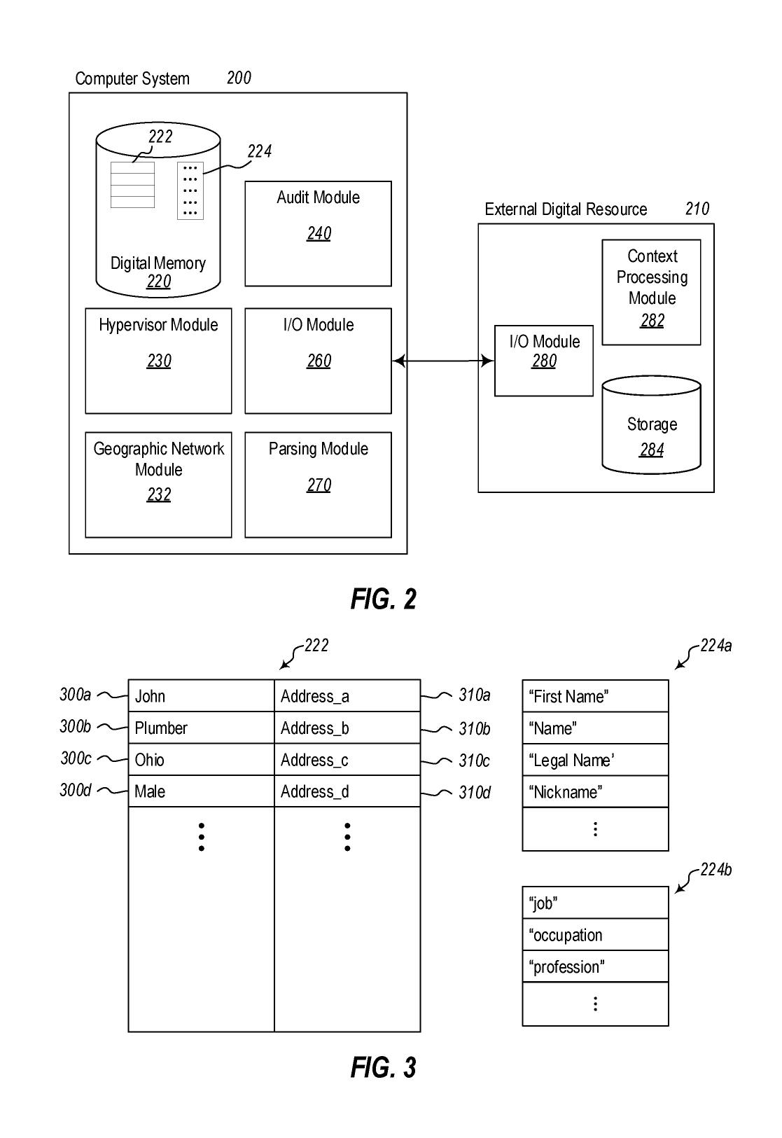

FIG. 2 illustrates an embodiment of a computer system 200 for validating an external digital resource 210, such as a website or application. The depicted embodiment of a computer system 200 comprises digital memory 220, a hypervisor module 230, a geographic network module 232, an audit module 240, an I/O module 260, and a parsing module 270. As will be described in greater detail below, each of these modules are operable to validate an external digital resource 210. One will understand, however, that the depicted modules are merely exemplary and are provided for the sake of clarity and explanation. In additional or alternative embodiments, the modules may be otherwise combined, divided, or related.

In at least one embodiment, the computer system 200 loads, into digital memory 220, a virtual user dataset 222 that includes one or more characteristics specific to a type of user. The virtual user dataset 222 may comprise a first virtual user data field (shown as 300a in FIG. 3) comprising a first value and a first dynamic address (shown as 310a in FIG. 3) linking an access dataset 224 to the first virtual user data field 300a. The access dataset 224 may comprise a plurality of pre-defined datatypes that each link through the first dynamic address 310a to the first virtual user data field.

In at least one embodiment, the various values within the virtual user data fields within the virtual user dataset 222 comprise characteristics of a particular type of user (also referred to herein as a “persona”). For example, the characteristics may describe a particular user's name, age, gender, race, location, phone number, web browsing history, and/or other similar information relating to the user. Additionally, in at least one embodiment, the virtual user dataset 222 comprises multiple different personas that can be selectively loaded to meet the needs of the computer system 200.

In at least one embodiment, the I/O module 260 within the computer system 200 communicates to another I/O module 280 associated with the external resource 210 and loads the external digital resource. In various embodiments, the external digital resource 210 may comprise a website, an email server, a software application, a server, a storage device, and/or any other source of digital information. Additionally, in at least one embodiment, the respective I/O modules 260, 280 may comprise computer APIs, buses, network cards, serial interfaces, parallel interfaces, or any other hardware and or software communication interfaces.

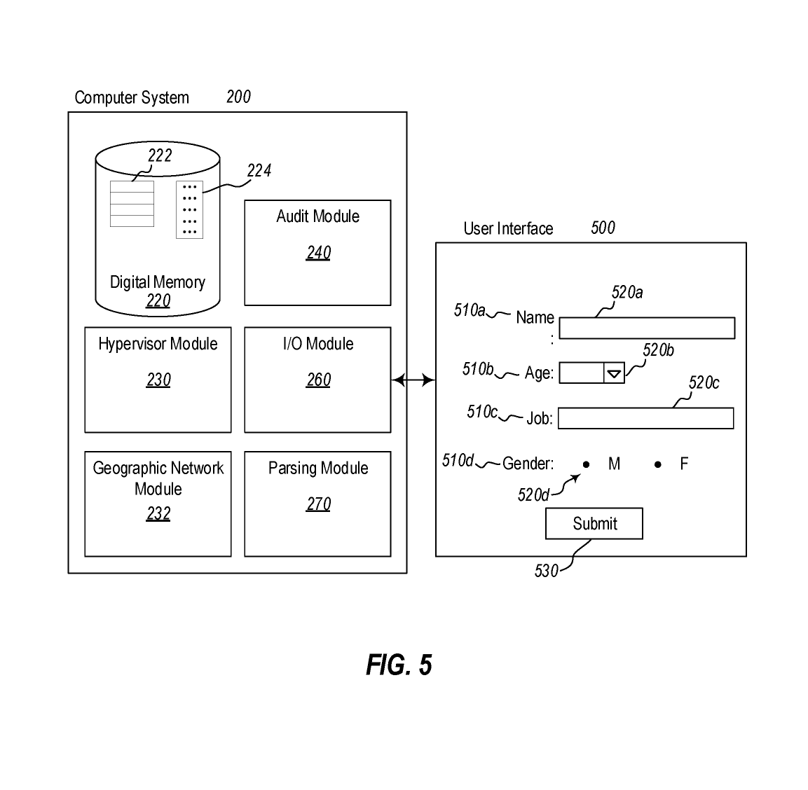

In at least one embodiment, the external digital resource 280 comprises one or more data entry fields (shown as 520(a-d) in FIG. 5). Additionally, in at least one embodiment, the external digital resource 210 is associated with a content processing module 282. The content processing module 282 is configured to process input, process data within storage, manage communications received from the I/O module and/or various other computing tasks.

In at least one additional or alternative embodiment, the external digital resource 210 does not comprise a content processing module 282, but instead relies upon the processing taking place on computer system 200. In response to the processing, the computer system 200 is capable of determining the proper location of data within the storage 284 and accessing the location in the external digital resource 210.

Once the external digital resource 210 is loaded by the computer system 200, the parsing module 270 parses the one or more data entry fields 520(a-d) received from the external digital resource 210. In at least one embodiment, parsing the one or more data entry fields 520(a-d) comprises identifying, within the external digital resource 210, field descriptions (shown as 510(a-d) in FIG. 5) associated with each data entry field selected from the one or more data entry fields 520(a-d). For example, as depicted in FIG. 5, the parsing module 270 is capable as identifying that field description 510a for “Name” is associated with data entry field 520a.

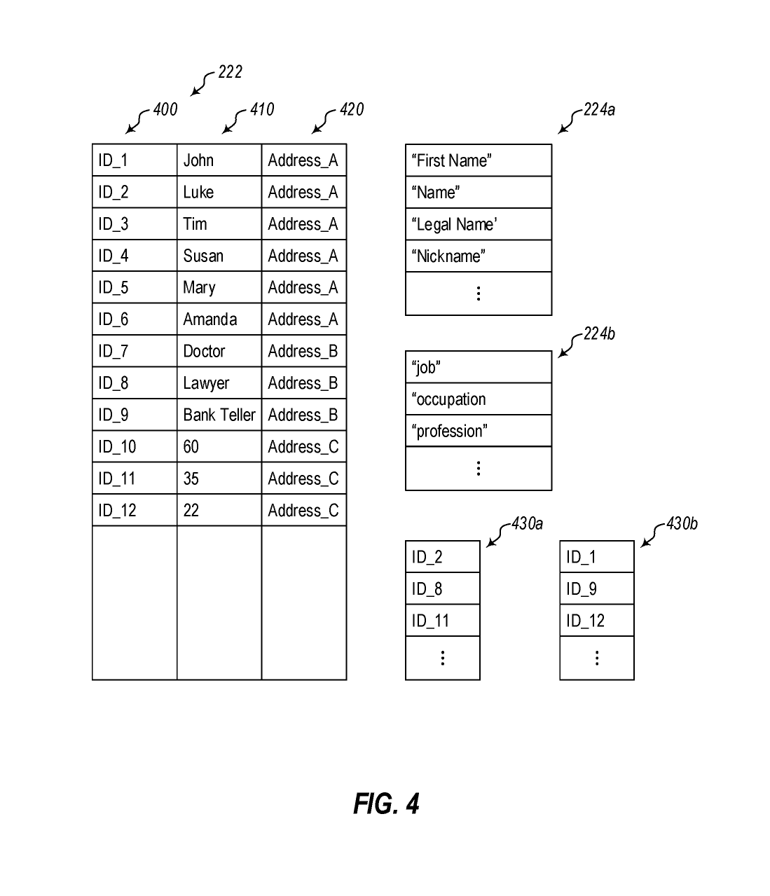

The parsing module 270 then identifies at least one data field description 510a within the first access dataset (shown as 224a in FIG. 3) that is associated with a first data entry field 520a. For example, the parsing module 270 identifies the data field description 510a of “Name” that is associated with data entry field 520a. The audit module 240 then searches various access datasets 224 for the data field description 510a “Name.” As depicted in FIG. 4, “Name” appears within access dataset 224a.

In at least one embodiment, each access dataset 224 is associated with a particular dynamic address. The dynamic addresses (shown as 310(a-d) in FIG. 3) are further each associated with values within the virtual user dataset 222. Once the parsing module 270 has identified that access dataset 224a comprises the data field description 510a “Name,” the parsing module 270 then accesses, through the first dynamic address 310a, the first value within the first virtual user data field 300a. In the example depicted in FIG. 3, the value comprises the name “John.”

In at least one embodiment, the parsing nodule 270 can also create a data file that contains the desired persona information for loading into the external digital resource 210. For example, the parsing module 270 can create a cookie data file. The cookie data file can then be communicated to the external digital resource 210. The external digital resource 210 can then process the persona information within the cookie data file.

In any case, the parsing module 270 then passes the first value (e.g., “John”) into the first data entry field 520a within the external digital resource 210. In at least one embodiment, the computer system 200 then initiates an audit of the external digital resource 210. When initiating the audit, the audit module 240 may causes the external digital resource 210 to execute a function. For example, the audit module 240 may cause the first value to be submitted to the external digital resource 210 through the submit button (shown as 530 in FIG. 5). One will appreciate, however, that that the audit module 240 may cause the external digital resource to execute a function through various other means.

Once the external digital resource 210 has executed the function, the audit module 240 can verify that an output of the external digital resource 210 matches a particular output that is linked to the first value. For example, in the case that the external digital resource 210 comprises a web form for joining a media campaign, entering the values into the data entry fields 520(a-d) may enroll a particular persona into the media campaign. In at least one embodiment, the resulting output comprises a marketing email. As such, the audit module 240 can process the marketing email and verify that it is properly formatted for the persona that it received.

In at least one embodiment, the audit module 240 also generates a report based on the audit. For example, the audit module 240 may have access to a template that indicates how a properly formatted output should appear on a persona-by-persona basis. The audit module 240 can compare the output generated by the external digital resource 210 to the template. Based upon the comparison, the audit module 240 can generate a report that describes each area where the output did not match the template.

In addition to storing various personas within the virtual user datasets 222, in at least one embodiment, the virtual user dataset comprises a technology profile that defines characteristics related to a virtual user's electronic device. For example, a technology profile may comprise a value within a virtual user data field that comprises a first digital address to a particular hypervisor environment. For example, different hypervisor environments may be available that are associated with different operating systems and/or hardware systems.

In at least one embodiment, a user may desire to audit an external digital resource 210 with a particular persona and particular technology profile. The hypervisor module 230 is configured to identify the technology profile and load the hypervisor environment that is addressed within the technology profile. In at least one embodiment, the address comprises a memory space address within the computer system, a network address, or an indication of the desired operating system and/or hardware system.

Once the hypervisor environment is loaded, the audit module 240, I/O module 260, and parsing module 270 can operate through the hypervisor environment with the external digital resource. For example, the parsing module 270 can load the external digital resource 210 within the hypervisor environment and then parse the content from within the hypervisor environment. In at least one embodiment, the parsing module 270 can generate a cookie data file or local storage file from the virtual user dataset 222 that can be loaded into a web browser cache with the hypervisor environment. The external digital resource 210, in this example a webserver, can then extract the data using conventional means. This would allow for the audit to validate the proper functioning the cookie extraction. As such, the external digital resource may only detect interactions with the hypervisor environment and may be otherwise unaware of the computer system 200.

Additionally, in at least one embodiment, the technology profile also comprises a geography value within a virtual user data field that includes a second digital address to a geographically defined network resource. As used herein, a geographically defined network resource comprises any network resource that appears to be geographically associated. In at least one embodiment, the geographically defined network resource comprises an internet protocol (IP) address that is associated with a geographic area referenced by the geography value. For example, the geographically defined network resource may comprise a proxy server located in the geographic area, a virtual private network (VPN), any other form of IP spoofing, or any other means to make it at least appear that a network location is originating from a particular geographic location.

In at least one embodiment, a user may desire to audit an external digital resource 210 with a particular persona, particular technology profile, and/or particular associated geography. The geographic network module 232 is configured to identify the geography value within the technology profile and load the appropriate geographically defined network resource that is associated within the geographic area referenced by the geography value. For example, the geographic network module 232 cause the I/O module 260 to communicate with the external digital resource 210 through a VPN that has an IP address associated with the desired geographic area.

Turning now to FIG. 3, FIG. 3 illustrates an embodiment of a virtual user dataset 222 and access datasets 224a, 224b. The virtual user dataset 222 comprises virtual user data fields 300(a-d) that comprise various values. Each field is associated with a dynamic address linking that links to various access datasets 224. For example, the virtual user dataset 222 comprises a persona that includes a name, occupation, home state, and gender (see 300(a-d)). Each value in the virtual user dataset 222 is associated with a different dynamic address linking to a different access dataset.

For example, user data field 300b comprises a value of “plumber.” User data field 300b is associated with a dynamic address that points to access dataset 224b. Access dataset 224b comprise a listing of synonyms for “job.” As such, when determining whether a data entry field should be associated with the pre-defined datatype stored in user data field 300b, the linked access dataset 224b can be searched. If a particular data entry field is looking for a “job,” “occupation,” or “profession,” then the data within the user data field 300b is of the appropriate pre-defined datatype. In contrast, user data field 300a is associated with a pre-defined datatype that relates to names.

FIG. 4 illustrates another embodiment of a virtual user dataset 222. In the depicted embodiment, the virtual user dataset 222 is associated with access datasets 224a, 224b, and persona datasets 430a, 430b. The virtual user dataset 222 comprises an identification column 400, a value column 410, and a dynamic address column 420. As depicted, in at least one embodiment, the virtual user dataset 222 may comprise information for multiple different personas. For example, the value column 410 comprises multiple names for different personas.

In at least one embodiment, a single virtual user dataset 222 can be used to generate multiple different personas. For instance, a user may create persona datasets 430a, 430b that create personas through references to identifications within the virtual user dataset 222. Persona dataset 430a comprises identifications that references “Luke,” “Lawyer,” and “35” within the virtual user dataset 222.

In at least one embodiment, the parsing module 270 prepares an individual persona based upon the persona datasets 430a, 430b. Additionally, in at least one embodiment, the parsing module 270 can randomly generate persona datasets 430a, 430b such that a large number of random personas are developed. The audit module 240 tracks the generated personas and performs audits based upon the returned results. As such, in at least one embodiment, the computer system 200 is configurable to automatically generate and iterate through personas.

FIG. 5 illustrates another embodiment of a system for validating a website or application. FIG. 5 depicts the computer system 200 as shown in FIG. 2. However, instead of showing the external digital resource 210, a user interface 500 that is associated with the external digital resource 210 is depicted. In at least one embodiment, the user interface 500 comprises a webpage for signing-up for a media campaign. The user interface comprises one or more data entry fields 520(a-d) and associated field descriptions 510(a-d). As depicted the data entry fields 520(a-d) may comprise a number of different types of data entry forms.

In at least one embodiment, once data is entered into the one or more data entry fields 520(a-d), the content processing module 282 (shown in FIG. 2) processes the received data. The content processing module 282 then generates a custom targeted message that is communicated to the user. The custom targeted message comprises various digital characteristics that the audit module 240 validates as being correctly associated with the persona, technology profile, and geographically defined network resource.

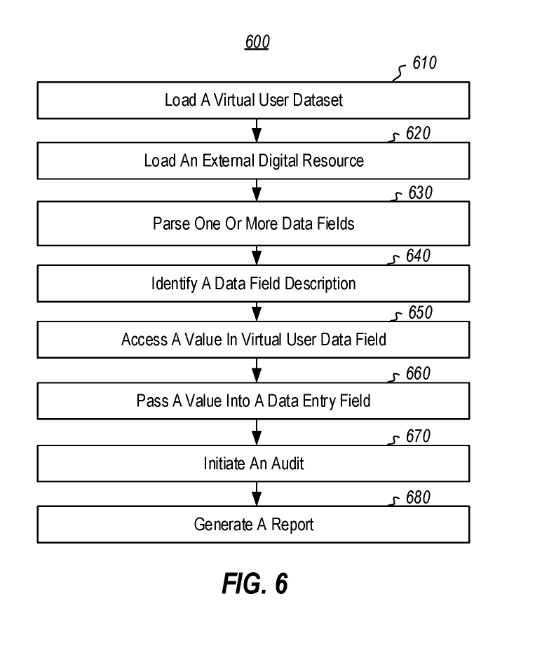

One will appreciate that the disclosed invention can also be described in terms of methods comprising one or more acts for accomplishing a particular result. For example, FIG. 6 and the corresponding text illustrate flowcharts of a sequence of acts in a method for performing audits with generated virtual user datasets. The acts of FIG. 6 are described below with reference to the components and modules illustrated in FIGS. 1-5.

For instance, FIG. 6 illustrates that a method 600 for performing audits with generated virtual user datasets comprises an act 610 of loading a virtual user dataset. Act 610 includes loading, into digital memory, a virtual user dataset that includes one or more characteristics specific to a type of user. The virtual user dataset comprises a first virtual user data field comprising a first value and a first dynamic address linking a first access dataset to the first virtual user data field. The first access dataset comprises a first plurality of pre-defined datatypes that each link through the first dynamic address to the first virtual user data field. For example, as depicted and described with respect to FIGS. 2-4, a parsing module 270 can load a virtual user data set 222 from digital memory 220. The virtual user dataset 222 comprises various user information and dynamic addresses (see 310(a-d)).

Additionally, FIG. 6 illustrates that method 600 comprises an act 620 of loading an external digital resource 210. Act 620 includes loading an external digital resource, wherein the external digital resource comprises one or more data entry fields. For example, as depicted and described with respect to FIGS. 2 and 5, the I/O module 260 is configured to load the external digital resource 210. In at least one embodiment, the external digital resource 210 comprises a webserver and loading the external digital resource 210 comprises rendering a user interface 500 that comprises data entry fields.

FIG. 6 also illustrates that method 600 comprises an act 630 of parsing one or more data fields. Act 630 includes parsing the one or more data entry fields, wherein parsing the one or more data entry fields comprises identifying, within the external digital resource, field descriptions associated with each data entry field selected from the one or more data entry fields. For example, as depicted and described in FIGS. 2 and 5, the parsing module 270 parses the user interface 500 and identifies the data entry fields 520(a-d) and the associated data field descriptions 510(a-d).

In addition, FIG. 6 illustrates that method 600 comprises an act 640 of identifying a data field description 640. Act 640 includes identifying at least one data field description within the first access dataset, wherein at least one data field description is associated with a first data entry field. For example, as depicted and described in FIGS. 2 and 5, the parsing module 270 parses the user interface 500 and identifies the data entry field 520a and the associated data field description 510a for “Name.”

FIG. 6 illustrates that the method 600 comprises an act 650 of accessing a value in the virtual user data field 650. Act 650 includes accessing, through the first dynamic address, the first value within the first virtual user data field. For example, as depicted and describe in FIGS. 2-4, the parsing module 270 is able to identify, through the access dataset 224 and the dynamic address, values within the virtual user dataset 222 that match the data field description.

FIG. 6 also illustrates that the method 600 comprises an act 660 of passing a value into a data entry field. Act 660 includes passing the first value into the first data entry field within the external digital resource. For example, as depicted and described in FIGS. 2 and 5, the parsing module 270 can extract values from the virtual user dataset 222 and enter them into the data entry fields 520(a-d). In at least one embodiment, entering the value comprises inputting them directly into the data entry fields 520(a-d). In contrast, in an additional or alternative embodiment, entering the values comprises generating cookies or other local storage data values that are responsive to data entry fields within the external digital resource 210. The external digital resource 210 is then capable of extracting the data from the cookie or from local storage.

Further, FIG. 6 illustrates that the method 600 comprises an act 670 of initiating an audit. Act 670 includes initiating an audit of the external digital resource. The audit comprises causing the external digital resource to execute a function and verifying an output of the external digital resource matches a particular output that is linked to the first value. For example, as depicted and described in FIGS. 1 and 2, an audit (or validation) is performed based upon the output of the external digital resource 210. For example, in at least one embodiment, the output comprises a message. The audit module validates or audits the message to verify that it properly conforms with characteristics that are dependent upon the previously entered virtual user dataset.

Further still, FIG. 6 illustrates that the method 600 comprises an act 680 of generating a report. Act 680 includes generating a report based on the audit. For example, as depicted and described with respect to FIGS. 1 and 2, a report generation module 113 is configured to generate a report that describes deficiencies that were identified during the audit.

Accordingly, one will appreciate in view of the above disclosure the value and technical challenge involved in auditing digital systems on a per-persona basis. Disclosed embodiments provide highly efficient systems and methods for incorporating persona data, technological profiles, and geographic variables into an audit system. Additionally, disclosed embodiments allow a user to control at a high level of detail the virtual user datasets that are fed into an external digital resource.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may comprise or utilize a special-purpose or general-purpose computer system that includes computer hardware, such as, for example, one or more processors and system memory, as discussed in greater detail below. The present invention can also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the present invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment may comprise a system that includes one or more hosts that are each capable of running one or more virtual machines. During operation, virtual machines emulate an operational computing system, supporting an operating system and perhaps one or more other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described preset invention is to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A method, implemented at a computer system that includes at least one processor, for dynamically loading digital audit data, the method comprising:
loading, into digital memory, a virtual user dataset that includes one or more characteristics specific to a type of user, wherein the virtual user dataset comprises:
a first virtual user data field comprising a first value, and
a first dynamic address linking a first access dataset to the first virtual user data field, wherein the first access dataset comprises a first plurality of pre-defined datatypes that each link through the first dynamic address to the first virtual user data field;
loading an external digital resource, wherein the external digital resource comprises one or more data entry fields;
parsing the one or more data entry fields, wherein parsing the one or more data entry fields comprises identifying, within the external digital resource, field descriptions associated with each data entry field selected from the one or more data entry fields;
identifying at least one data field description within the first access dataset, wherein the at least one data field description is associated with a first data entry field;
accessing, through the first dynamic address, the first value within the first virtual user data field;
passing the first value into the first data entry field within the external digital resource;
initiating an audit of the external digital resource, wherein the audit comprises:
causing the external digital resource to execute a function, and
verifying an output of the external digital resource matches a particular output that is linked to the first value; and
generating a report based on the audit.

2. The method of claim 1, wherein the virtual user dataset further comprises:
a second virtual user data field comprising a second value; and
a second dynamic address linking a second access dataset to the second virtual user data field, wherein the second access dataset comprises a second plurality of pre-defined datatypes that each link through the second dynamic address to the second virtual user data field, wherein:
the first value is different than the second value, and
the first plurality of pre-defined datatypes is different than the second plurality of pre-defined datatypes.

3. The method of claim 1, wherein the virtual user dataset comprises a technology profile that defines characteristics related to a virtual user's electronic device.

4. The method of claim 3, wherein the technology profile comprises:
a third value within a third virtual user data field, the third value comprising a first digital address to a particular hypervisor environment; and
the hypervisor environment comprises a particular operating system that is associated with the third value.

5. The method of claim 4, wherein the technology profile comprises:
a fourth value within a fourth virtual user data field, the fourth entry comprising a second digital address to a geographically defined network resource; and
the geographically defined network resource comprises an internet protocol (IP) address that is associated with a geographic area, wherein the fourth value corresponds to the geographic area.

6. The method of claim 5, wherein the geographically defined network resource comprises a proxy server located within the geographic area.

7. The method of claim 4, wherein loading the external digital resource is performed within the hypervisor environment.

8. The method of claim 7, wherein the virtual user dataset is stored within a cookie in web browser cache within the hypervisor environment.

9. The method of claim 7, wherein the virtual user dataset is stored within a local storage within the hypervisor environment.

10. The method of claim 9, wherein the first value comprises a telephone number.

11. A computer system for dynamically loading digital audit data comprising:
one or more processors; and
one or more computer-readable media having stored thereon executable instructions that when executed by the one or more processors configure the computer system to perform at least the following:
load, into digital memory, a virtual user dataset that includes one or more characteristics specific to a type of user, wherein the virtual user dataset comprises:
a first virtual user data field comprising a first value, and
a first dynamic address linking a first access dataset to the first virtual user data field, wherein the first access dataset comprises a first plurality of pre-defined datatypes that each link through the first dynamic address to the first virtual user data field;
load an external digital resource, wherein the external digital resource comprises one or more data entry fields;
parse the one or more data entry fields, wherein parsing the one or more data entry fields comprises identifying, within the external digital resource, field descriptions associated with each data entry field selected from the one or more data entry fields;
identify at least one data field description within the first access dataset, wherein the at least one data field description is associated with a first data entry field;
access, through the first dynamic address, the first value within the first virtual user data field;
pass the first value into the first data entry field within the external digital resource;
initiate an audit of the external digital resource, wherein the audit comprises:
causing the external digital resource to execute a function, and
verifying an output of the external digital resource matches a particular output that is linked to the first value; and
generating a report based on the audit.

12. The computer system of claim 11, wherein the virtual user dataset further comprises:
a second virtual user data field comprising a second value; and
a second dynamic address linking a second access dataset to the second virtual user data field, wherein the second access dataset comprises a second plurality of pre-defined datatypes that each link through the second dynamic address to the second virtual user data field, wherein:
the first value is different than the second value, and
the first plurality of pre-defined datatypes is different than the second plurality of pre-defined datatypes.

13. The computer system of claim 11, wherein the virtual user dataset comprises a technology profile that defines characteristics related to a virtual user's electronic device.

14. The computer system of claim 13, wherein the technology profile comprises:
a third value within a third virtual user data field, the third entry comprising a first digital address to a particular hypervisor environment; and
the hypervisor environment comprises a particular operating system that is associated with the third value.

15. The computer system of claim 14, wherein the technology profile comprises:
a fourth value within a fourth virtual user data field, the fourth entry comprising a second digital address to a geographically defined network resource; and
the geographically defined network resource comprises an internet protocol (IP) address that is associated with a geographic area, wherein the fourth value corresponds to the geographic area.

16. The computer system of claim 15, wherein the geographically defined network resource comprises a proxy server located within the geographic area.

17. The computer system of claim 14, wherein loading the external digital resource is performed within the hypervisor environment.

18. The computer system of claim 17, wherein the virtual user dataset is stored within a cookie in web browser cache within the hypervisor environment.

19. The method of claim 17, wherein the virtual user dataset is stored within a local storage within the hypervisor environment.

20. A computer program product comprising one or more computer storage media having stored thereon computer-executable instructions that, when executed at a processor, cause the computer system to perform a method for dynamically loading digital audit data, the method comprising:
loading, into digital memory, a virtual user dataset that includes one or more characteristics specific to a type of user, wherein the virtual user dataset comprises:
a first virtual user data field comprising a first value, and
a first dynamic address linking a first access dataset to the first virtual user data field, wherein the first access dataset comprises a first plurality of pre-defined datatypes that each link through the first dynamic address to the first virtual user data field;
loading an external digital resource, wherein the external digital resource comprises one or more data entry fields;
parsing the one or more data entry fields, wherein parsing the one or more data entry fields comprises identifying, within the external digital resource, field descriptions associated with each data entry field selected from the one or more data entry fields;
identifying at least one data field description within the first access dataset, wherein the at least one data field description is associated with a first data entry field;
accessing, through the first dynamic address, the first value within the first virtual user data field;
passing the first value into the first data entry field within the external digital resource;
initiating an audit of the external digital resource, wherein the audit comprises:
causing the external digital resource to execute a function, and
verifying an output of the external digital resource matches a particular output that is linked to the first value; and
generating a report based on the audit.
